(19) United States
(12) Patent Application Publication
(10) Pub. No.: US 2025/0253109 A1
(43) Pub. Date: Aug. 7, 2025

(54) VARIABLE FORCE ADJUSTABLE SWITCH

(71) Applicant: HONEYWELL INTERNATIONAL INC., Charlotte, NC (US)

(72) Inventors: Hari Suriya REDDY, Charlotte, NC (US); HUSSAIN, Charlotte, NC (US); Vijaya Krishna Nageshchar KORALAHALLI, Charlotte, NC (US)

(21) Appl. No.: 19/029,584

(22) Filed: Jan. 17, 2025

(30) Foreign Application Priority Data
Feb. 2, 2024 (IN) 202411007117

(51) Int. Cl. H01H 19/14; H01H 3/38

(52) U.S. Cl. CPC H01H 19/14; H01H 3/38

(57) ABSTRACT

A switch comprising a knob configured to rotate, the knob comprising a stepped structure. The switch further comprises at least one detent positioned over the stepped structure of the knob. The switch further comprises at least one plunger positioned inside the knob. The switch further comprises at least one helical spring positioned in between the at least one plunger and at least one detent, to have a preload compression force. Further, rotation of the knob causes the at least one detent to move along the stepped structure to vary the preload compression force of the at least one helical spring.

### CROSS-REFERENCE TO RELATED APPLICATION

This application claims priority pursuant to 35 U.S.C. 119 (a) to Indian application Ser. No. 202411007117, filed Feb. 2, 2024, which application is incorporated herein by reference in its entirety.

### TECHNOLOGICAL FIELD

Example embodiments of the present disclosure relate generally to a switch, and more particularly, to a variable force adjustable switch and method of varying force required for operating the variable force adjustable switch.

### BACKGROUND

Electromechanical switches are electrical circuit components that enable, interrupt or disable the flow of electric current from a power source through mechanical mediums. Electromechanical switches facilitate in operations such as make, break, or change the current flow from one circuit to another, by using a principle that requires mechanical actuators to regulate operation of such electromechanical switches. The electromechanical switches often consist of movable connector terminals, with mechanical action facilitating electrical connections or disconnections. The electromechanical switches demand a particular amount of operational force to open or close the circuit. However, the electromechanical switches lack in providing flexible operating forces for a specific system-switch interface. Sometimes, due to damaged components or degraded quality of the switch, the required operational force increases or decreases thereby limiting the accuracy of such electromechanical switches while opening or closing the circuit. Additionally, the electromechanical switches with high operational forces may have a shorter lifespan due to increased wear and tear of the components. Further, frequent and forceful actuation may lead to premature degradation of the electromechanical switches, reducing its reliability over time and necessities more frequent replacements and maintenance.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates an isometric view of a variable force adjustable switch in accordance with an example embodiment of the present disclosure;

FIG. 2A illustrates an exploded view of the variable force adjustable switch in accordance with an example embodiment of the present disclosure;

FIG. 2B illustrates an isometric view of a knob in accordance with an example embodiment of the present disclosure;

FIG. 2C illustrates an isometric view of at least one detent in accordance with an example embodiment of the present disclosure;

FIG. 3A illustrates a front sectional view of the variable force adjustable switch in accordance with an example embodiment of the present disclosure;

FIG. 3B illustrates an enlarged view of a stepped structure of the knob in accordance with an example embodiment of the present disclosure;

FIG. 3C illustrates a side sectional view of the variable force adjustable switch in accordance with an example embodiment of the present disclosure; and,

FIG. 4 illustrates a flowchart showing a method of varying force required for operating the variable force adjustable switch in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

As used herein, the term “positioned directly between” refers to a first component being positioned between a second component and a third component such that the first component makes contact with both the second component and the third component. In contrast, a first component that is “positioned in between” a second component and a third component may or may not have contact with the second component and the third component. Additionally, a first component that is “positioned in between” a second component and a third component is positioned such that there may be other intervening components between the second component and the third component other than the first component.

The present disclosure provides various embodiments of a variable force adjustable switch and methods to operate the variable force adjustable switch. Embodiments may be configured to regulate an operating force of a switch. Embodiments may be configured to rotate a knob in clockwise direction or in an anticlockwise direction to change the operating force of the switch. Embodiments may be configured to move at least one detent inside the knob over a stepped structure. Embodiments may be configured to compress at least one helical spring between a plunger and at least one detent to modulate and/or adjust compression force of the at least one helical spring. Embodiments may be configured to change operating force of the plunger by altering the compression force of at least one helical spring. Embodiments may provide different settings and modes that allow integrations of the variable force adjustable switch into various industrial settings and/or household applications.

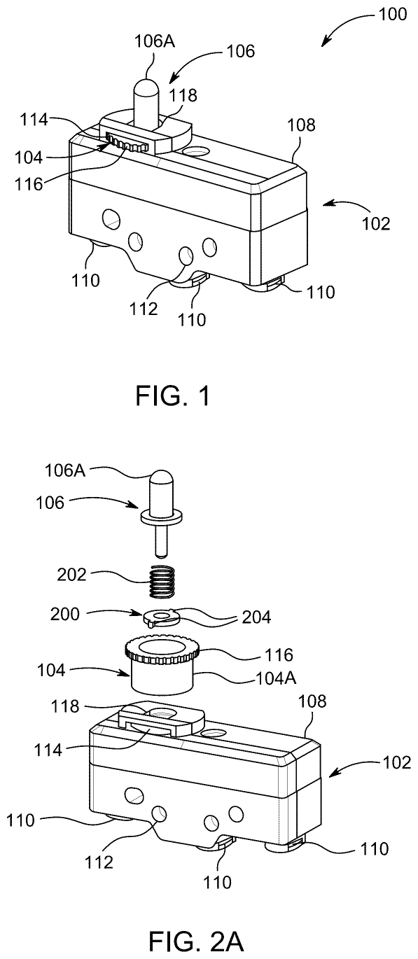

FIG. 1 illustrates an isometric view of a variable force adjustable switch 100, in accordance with an example embodiment of the present disclosure.

In some embodiments, variable force adjustable switch 100 may be connected between at least one power source (not shown) and a load circuit (not shown). Variable force adjustable switch 100 may be configured to make or break electric current to the load circuit. Variable force adjustable switch 100 may comprise a knob 104. Variable force adjustable switch 100 may comprise a housing 102. Knob 104 may be configured to rotate in a clockwise direction or in an anticlockwise direction relative to housing 102. Further, variable force adjustable switch 100 may comprise at least one plunger 106 positioned at least partially inside knob 104. At least one plunger 106 may be coupled, directly or indirectly, to knob 104. In some embodiments, housing 102 may be constructed with a material selected from a group of materials such as, but not limited to, metal, plastic, or alloys. Further, housing 102 may provide an enclosed structure that may at least partially encase around knob 104 and at least one plunger 106. Housing 102 may include a top cover 108 that may be snapped-fit over a base of housing 102 using one or more locks (not shown) crafted on housing 102. The top cover 108 may be configured to provide covering to knob 104 and at least one plunger 106.

Further, housing 102 may comprise one or more screw terminals 110. One or more screw terminals 110 may be configured to electrically couple variable force adjustable switch 100 with at least one power source, and the load circuit via at least one connecting media (not shown). One or more screw terminals 110 may be configured to be coiled with the at least one connecting media and fastened within one or more terminal outlets (not shown). The at least one connecting media may correspond to one or more electric wires. The one or more terminal outlets are fabricated over housing 102. In some embodiments, the one or more terminal outlets may be configured to allow connection of the variable force adjustable switch 100 between the at least one power source and the load circuit. In an example embodiment, the one or more terminal outlets may include at least one common terminal (COM1), at least one normally closed terminal (NC2), and at least one normally open terminal (NO3). Further, housing 102 may be crafted with a plurality of mounting holes 112. The plurality of mounting holes 112 may be configured to allow mounting of the variable force adjustable switch 100 with one or more peripherals of one or more external devices. The mounting of the variable force adjustable switch 100 with one or more peripherals may enable variable force adjustable switch 100 to turn the external devices on/off, or to switch between multiple external devices. In an example embodiment, the one or more external devices may include at least one of an air conditioner (A/C), refrigerator, or any other external device known in the art.

Further, top cover 108 may be fabricated with at least one slit 114 that provides a cavity to expose a radial protrusion 116 of knob 104 from top cover 108. In some embodiments, radial protrusion 116 of knob 104 may protrude at least partially exterior to at least one slit 114. In some embodiments, radial protrusion 116 may provide grip to a user while rotating knob 104 in a clockwise direction, or in an anticlockwise direction. Further, top cover 108 may be fabricated with at least one slot 118 that provides a cavity to partially expose a predefined portion 106A of at least one plunger 106 exterior from top cover 108. In an exemplary embodiment, predefined portion 106A of the at least one plunger 106 may be configured to be pressed by the user in a vertical direction upon application of an external force.

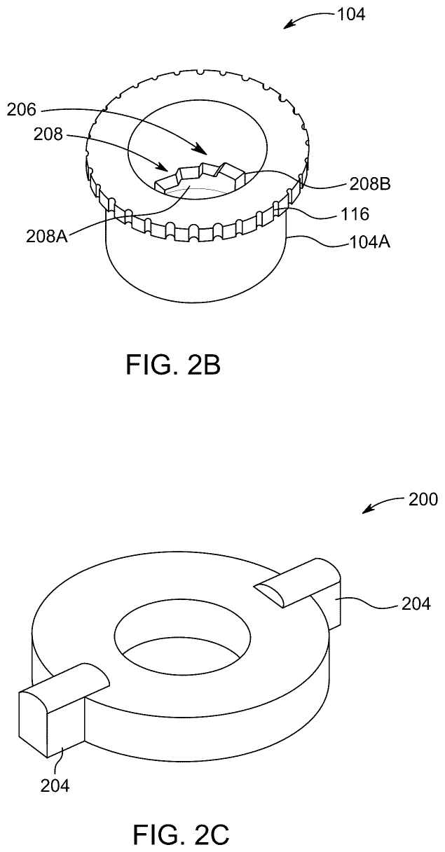

FIG. 2A illustrates an exploded view of the variable force adjustable switch 100, in accordance with an example embodiment of the present disclosure. FIG. 2B illustrates an isometric view of knob 104, in accordance with an example embodiment of the present disclosure. FIG. 2C illustrates an isometric view of the at least one detent, in accordance with an example embodiment of the present disclosure. FIGS. 2A-2C are described in conjunction with FIG. 1.

In some embodiments, knob 104 may further comprise a hollow cylinder 104A. Hollow cylinder 104A may be positioned partially interior to housing 102. Knob 104 further comprises at least one detent 200. In some embodiments, at least one detent 200 may be crafted in one or more shapes. In one example embodiment, the one or more shapes may include a circular shape, a semi-circular shape or any other shape known in the art. Further, at least one detent 200 may be configured to experience a vertical movement during rotation of knob 104. Further, at least one helical spring 202 may be positioned in between at least one plunger 106 and at least one detent 200.

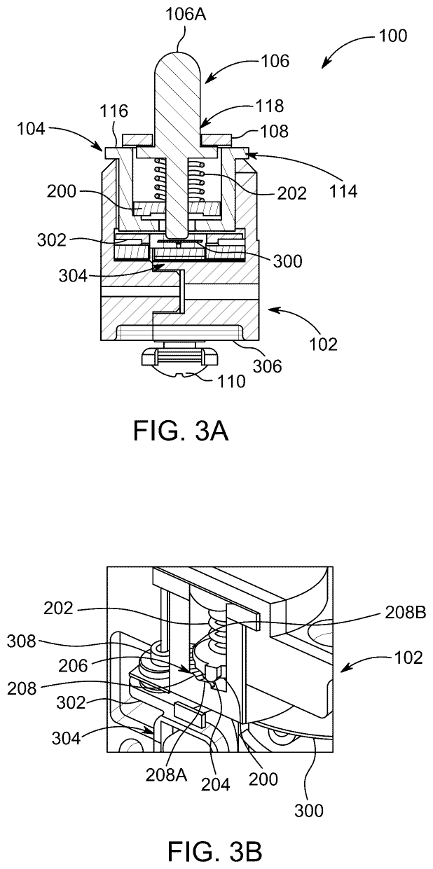

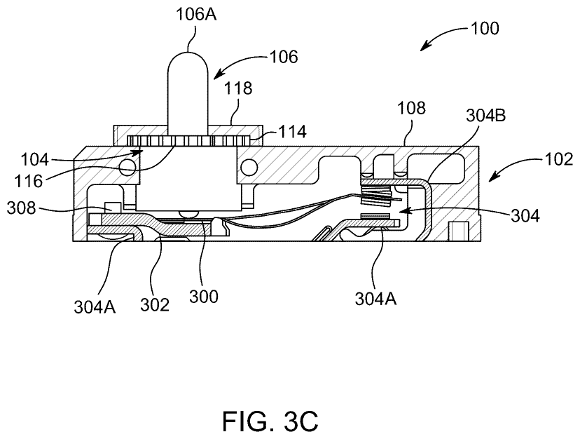

In an exemplary embodiment, at least one detent 200 may be crafted with one or more protruded sections 204, as shown in FIG. 2C. One or more protruded sections 204 may provide support to the at least one detent 200 inside knob 104. The one or more protruded sections 204 may further be configured to slide along surface of a stepped structure 206 of knob 104 to control the vertical movement of at least one detent 200. It may be noted that the detailed working of at least one detent 200 with stepped structure 206 along with at least one helical spring 202, will be explained in FIGS. 3A-3C.

In some embodiments, stepped structure 206 may be configured to rotate along the same direction as of knob 104. Further, rotation of stepped structure 206 may allow one or more protruded sections 204 of at least one detent 200 to move along stepped structure 206. In some embodiments, stepped structure 206 may comprise a plurality of steps 208 arranged in varying order of height as shown in FIG. 2B. In some embodiments, a plurality of steps 208 may collectively define a first end 208A and a second end 208B. Further, a plurality of steps 208 may define a gradient such that the height of each of a plurality of steps 208 sequentially increases from the first end 208A of the plurality of steps 208 to the second end 208B of the plurality of steps 208. In some embodiment, the height of each of the plurality of steps 208 from the first end 208A of the plurality of steps 208 to the second end 208B of the plurality of steps 208 may be at least H1 and up to H2. The varying order of height of the plurality of steps 208 may allow a multi-step adjustment of at least one detent 200 over stepped structure 206.

In one exemplary embodiment, the height of the plurality of steps 208 may increase such that H2>H1. As one or more protruded sections 204 of at least one detent 200 may slide over a plurality of steps 208 of the height H1 to H2, at least one detent 200 may move vertically upwards. In one embodiment, the height of the plurality of steps 208 may vary based at least on the range of the operating force. The vertical movement of at least one detent 200 may further allow at least one helical spring 202 to compress between at least one detent 200 and at least one plunger 106. As a result of the compression of at least one helical spring 202, a preload compression of at least one helical spring 202 may vary that adjusts operating force of at least one plunger 106. In an exemplary embodiment, the clockwise, or anticlockwise rotations of knob 104 may enable variations in preload compression of at least one helical spring 202. In some embodiments, differences between the height of each of the plurality of steps 208 may allow control of vertical movement of at least one detent 200, thereby controlling preload compression of at least one helical spring 202.

FIG. 3A illustrates a front sectional view of the variable force adjustable switch 100, in accordance with an example embodiment of the present disclosure. FIG. 3B illustrates an enlarged view of stepped structure 206 of knob 104, in accordance with an example embodiment of the present disclosure. FIG. 3C illustrates a side sectional view of variable force adjustable switch 100, in accordance with an example embodiment of the present disclosure. FIGS. 3A-3C are described in conjunction with FIGS. 1-2C.

In some embodiments, variable force adjustable switch 100 may comprise at least one supporting structure 302, one or more conductors 304, one or more terminal outlets 306 and at least one rivet 308. In some embodiments, the variable force adjustable switch 100 may further comprise at least one leaf spring 300 positioned within housing 102. The at least one leaf spring 300 may be positioned in proximity to at least one plunger 106. The at least one leaf spring 300 may be configured to control breaking or making circuit between the at least one power source and/or the load circuit on application of the operating force by at least one plunger 106. In some embodiments, at least one leaf spring 300 may be configured to break or make the circuit attached to variable force adjustable switch 100 once the operating force exceeds a predefined threshold of the operating force applied on at least one plunger 106. It may be noted that variable force adjustable switch 100 may withstand any range of the operating force. Upon applying the operating force above the threshold value, at least one plunger 106 may move vertically downwards to press at least one helical spring 202.

In some embodiments, the operating force may correspond to an addition of a preload compression force of at least one helical spring 202, and the force offered by at least one leaf spring 300. In some embodiments, the preload compression of the at least one helical spring 202 may regulate the range of force required to operate at least one plunger 106 as the vertical displacement of at least one plunger 106 alter as per user's requirements. As shown in FIG. 3B, the preload compression of at least one helical spring 202 may be varied via stepped structure 206. Stepped structure 206 may be configured to rotate along the same direction as of the knob 104. Further, rotation of the stepped structure 206 may allow the one or more protruded sections 204 of at least one detent 200 to move along the stepped structure 206 from the first end 208A of the plurality of steps 208 to the second end 208B of the plurality of steps 208. The rotation of stepped structure 206 may thereby force at least one detent 200 to move vertically upwards along the knob 104.

The vertical movement of the at least one detent 200 may further allow the at least one helical spring 202 to compress between at least one detent 200 and at least one plunger 106. As a result of the compression of at least one helical spring 202, the preload compression of at least one helical spring 202 may vary, which may adjust the operating force of the at least one plunger 106. In some embodiments, the range of force required to operate at least one plunger 106 may be applied directly depending on an angle of rotation of the knob 104. In some embodiments, the angle of rotation may correspond to a degree of rotation of knob 104. In some embodiments, the relation between the angle of rotation, number of the plurality of steps 208 and the height of each of the plurality of steps 208 may depend on the range of force required. In an exemplary embodiment, the additional force applied on at least one plunger 106 may be directly transferred to at least one leaf spring 300. In some embodiments, at least one leaf spring 300 may snap over to break or make a circuit once an operating force is received by at least one plunger 106. In some embodiments, the operating force may be an addition of a preload compression of at least one helical spring 202 and force offered by at least one leaf spring 300.

In some embodiments, housing 102 may be integrated with the at least one rivet 308, as shown in FIGS. 3B-3C. The at least one rivet 308 may be configured to secure at least one leaf spring 300 inside housing 102 via the at least one supporting structure 302. The at least one rivet 308 may prevent loosening of at least one leaf spring 300 after an overtime usage of variable force adjustable switch 100. In some embodiments, at least one supporting structure 302 may be constructed with a material selected from a group of insulating material including at least one plastic, alloy or alike. Further, at least one supporting structure 302 maintains stabilized positioning of at least one leaf spring 300 inside housing 102. In an exemplary embodiment, at least one leaf spring 300 is a conductive element that may be integrated into switches to connect or disconnect circuits.

In some embodiments, at least one leaf spring 300, upon receiving additional force from at least one plunger 106, may flex to make contact with the one or more conductors 304. One or more conductors 304 may be electrically connected with variable force adjustable switch 100. Further, contact of at least one leaf spring 300 with one or more conductors 304 may close the circuit and further, may allow current to flow from one or more power sources to the one or more conductors. In some embodiments, one or more conductors 304 may comprise at least one positive conductor 304A, and at least one negative conductor 304B. In an exemplary embodiment, after flexing of at least one leaf spring 300, at least one positive conductor 304A makes contact with at least one negative conductor 304B. Further, the connection of at least one positive conductor 304A with at least one negative conductor 304B may initiate current to flow from the one or more power sources to one or more conductors 304.

In some embodiments, housing 102 may further comprise the one or more terminal outlets 306. As explained above, one or more terminal outlets 306 may be configured to allow connection of variable force adjustable switch 100 between the at least one power source and the load circuit. In some embodiments, one or more conductors 304 may be electrically coupled with one or more terminals outlets 306. In an exemplary embodiment, one or more terminal outlets 306 may be configured to allow connection of variable force adjustable switch 100 between the at least one power source and the load circuit. It will be apparent to one skilled in the art that the above-mentioned components of variable force adjustable switch 100 have been provided only for illustration purposes, without departing from the scope of the disclosure.

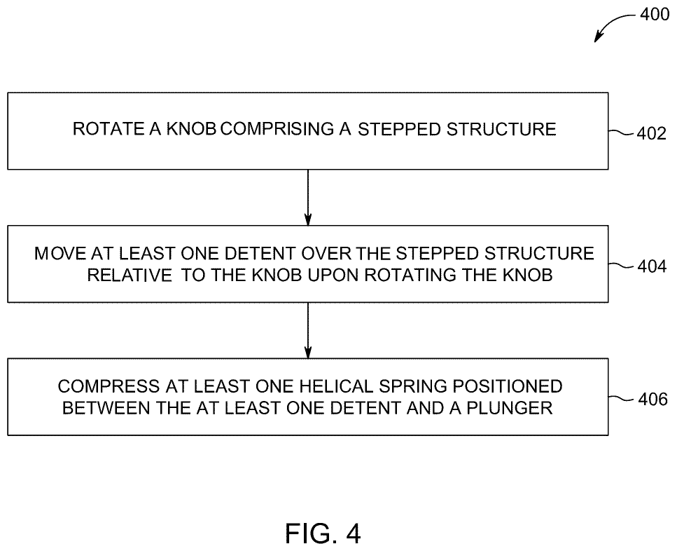

FIG. 4 illustrates a flowchart showing a method 400, in accordance with an example embodiment of the present disclosure. FIG. 4 is described in conjunction with FIGS. 1-3C.

At operation 402, knob 104 installed within the housing 102 is rotated. In some embodiments, knob 104 may be provided with a radial protrusion 116 that may provide grip to the user while rotating knob 104 in a clockwise or anticlockwise direction inside housing 102. At operation 404, at least one detent 200 is moved via stepped structure 206 fabricated inside knob 104 upon rotating knob 104. As discussed above, at least one detent 200 may be crafted with one or more protruded sections 204 that may provide support of at least one detent 200 over stepped structure 206. In some embodiments, stepped structure 206 may comprise plurality of steps 208 arranged in varying order of height. Further, the varying order of height of the plurality of steps 208 may allow a multi-step adjustment of at least one detent 200 over stepped structure 206. Further, the height of each of the adjacent plurality of steps 208 may be at least H1 and up to H2. In some embodiments, the height varies based at least on a range of the operating force. In some embodiments, the plurality of steps 208 may collectively define the first end 208A and the second end 208B. Further, the plurality of steps 208 may define a gradient such that the height of each of the plurality of steps 208 sequentially increases from the first end 208A to the second end 208B. In some embodiments, difference between the height of each of the plurality of steps 208 may allow control of vertical movement of at least one detent 200.

At operation 406, at least one helical spring 202 positioned between at least one detent 200 and at least one plunger 106, is compressed to vary preload compression force of at least one helical spring 202. In some embodiments, at least one helical spring 202 may be positioned in between at least one plunger 106 and at least one detent 200. In some embodiments, at least one detent 200 may be crafted with one or more shapes. In an example embodiment, the one or more shapes may include at least a circular shape, a semi-circular shape or any other shape known in the art. Further, the at least one helical spring 202 may be configured to compress and expand during the vertical movement of at least one helical spring 202. In some embodiments, the at least one helical spring 202 may be configured to store potential energy upon application of the external force on at least one plunger 106. In some embodiments, difference between the height of each of the plurality of steps 208 may allow to control of vertical movement of at least one detent 200 and thereby control the preload compression of at least one helical spring 202.

In some embodiments, at least one detent 200 may be positioned over stepped structure 206 of knob 104. In some embodiments, at least one detent 200 may be fabricated with one or more protruded sections 204. Further, one or more protruded sections 204 may be configured to slide along the surface of each of the plurality of steps 208 to control vertical movement of at least one detent 200. In an exemplary embodiment, the one or more protruded sections 204 may be crafted with curved edges to provide ease to one or more protruded sections 204 while moving over the plurality of steps 208.

In an exemplary embodiment, the additional force applied on at least one plunger 106 may be directly transferred to at least one leaf spring 300. In some embodiments, at least one leaf spring 300 may snap over to break or make circuit once an operating force is received by at least one plunger 106. In some embodiments, the operating force may be an addition of the preload compression of at least one helical spring 202 and force offered by at least one leaf spring 300.

In an exemplary embodiment, at least one leaf spring 300 may be a conductive element that may be integrated into switches to connect or disconnect circuits. Herein, at least one leaf spring 300 upon receiving the additional force from at least one plunger 106 may flex to make contact with one or more conductors 304 and may be electrically connected with variable force adjustable switch 100. Further, the contact of at least one leaf spring 300 with one or more conductors 304 closes the circuit and thereafter allows current to flow from one or more power sources to one or more conductors 304.

In some embodiments, the present disclosure allows altering the operating force of the plunger of variable force adjustable switch 100. The present disclosure allows to alter the operating force of the plunger in multiple steps which is best suited for an electrical appliance connected to variable force adjustable switch 100. In some embodiments, variable force adjustable switch 100 is designed to meet standard operating forces (O.F) driven by leaf spring design. In some embodiments, the present disclosure eliminates any need to manufacture or order electromechanical switches of different parameters. The present disclosure may also assure a longer lifespan of variable force adjustable switch 100. The present disclosure may reduce the necessities of more frequent replacements and maintenance.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A switch comprising:
a knob configured to rotate, the knob comprising a stepped structure;
at least one detent positioned over the stepped structure of the knob;
at least one plunger positioned inside the knob; and,
at least one helical spring positioned in between the at least one plunger and at least one detent, to have a preload compression force,
wherein rotation of the knob causes the at least one detent to move along the stepped structure to vary the preload compression force of the at least one helical spring.

2. The switch of claim 1, wherein the stepped structure is configured to control vertical movement of the at least one detent and thereby varying the preload compression force on the at least one helical spring.

3. The switch of claim 2, wherein the at least one detent is fabricated with one or more protruded sections, wherein the one or more protruded sections are configured to slide along surface of each of the stepped structure to control the vertical movement of the at least one detent.

4. The switch of claim 1, wherein the stepped structure comprises a plurality of steps arranged in varying order of height.

5. The switch of claim 4, wherein the height of each of the plurality of steps is at least H1 and up to H2, and wherein the height varies based at least on a range of an operating force.

6. The switch of claim 5, wherein the preload compression force of the at least one helical spring is configured to vary the operating force applied on the at least one plunger, due to the movement of the at least one detent over the plurality of steps.

7. The switch of claim 6, further comprising at least one leaf spring disposed in proximity to the at least one plunger, wherein upon applying the operating force, the at least one plunger moves vertically downwards to snap over the at least one leaf spring.

8. The switch of claim 7, wherein the at least on leaf spring is configured to break or make a circuit attached to the switch once the operating force exceeds a predefined threshold of the operating force applied on the at least one plunger.

9. The switch of claim 7, wherein the operating force corresponds to an addition of the preload compression force of the at least one helical spring and force offered by the at least one leaf spring.

10. The switch of claim 6, wherein the height of each of the plurality of steps combined with an angle of rotation of the knob provides a varying range of the operating force applied on the at least one plunger.

11. The switch of claim 1, further comprising a housing, wherein the knob comprises a hollow cylindrical body and a radial protrusion extending away from the hollow cylindrical body, and wherein:
the hollow cylindrical body of the knob is positioned at least partially interior to the housing, and,
the radial protrusion is positioned at least partially exterior to the housing.

12. A method comprising:
rotating a knob comprising a stepped structure;
moving at least one detent over the stepped structure relative to the knob and based on the rotation of the knob; and,
compressing at least one helical spring positioned between the at least one detent and at least one plunger, to vary preload compression force of the at least one helical spring.

13. The method of claim 12, wherein the stepped structure is configured to control vertical movement of the at least one detent and thereby varying the preload compression force on the at least one helical spring.

14. The method of claim 13, wherein the at least one detent is fabricated with one or more protruded sections, wherein the one or more protruded sections are configured to slide along surface of the stepped structure to control the vertical movement of the at least one detent.

15. The method of claim 12, wherein the stepped structure comprises a plurality of steps arranged in varying order of height.

16. The method of claim 15, wherein the height of each of the plurality of steps is at least H1 and up to H2, and wherein the height varies based at least on a range of an operating force.

17. The method of claim 16, wherein the preload compression force of the at least one helical spring is configured to vary the operating force applied on the at least one plunger, due to the movement of the at least one detent over the plurality of steps, and wherein the height of each of the plurality of steps combined with an angle of rotation of the knob provides a varying range of the operating force applied on the at least one plunger.

18. The method of claim 17, further comprises at least one leaf spring disposed in proximity to the at least one plunger, wherein upon applying the operating force, the at least one plunger moves vertically downwards to snap over the at least one leaf spring.

19. The method of claim 18, wherein the at least on leaf spring is configured to break or make a circuit attached to the switch once the operating force exceeds a predefined threshold of the operating force applied on the plunger.

20. The method of claim 18, wherein the operating force corresponds to an addition of the preload compression force of the at least one helical spring and force offered by the at least one leaf spring.
